(19) United States
(12) Patent Application Publication
(10) Pub. No.: US 2022/0215146 A1
(43) Pub. Date: Jul. 7, 2022

(54) METHOD FOR RECOGNIZING ANALOG CIRCUIT STRUCTURE

(71) Applicant: AnaGlobe Technology, Inc., Hsinchu City (TW)

(72) Inventors: Po-Hung Lin, Hsinchu County (TW); Zheng-Yao Liu, New Taipei City (TW); Jun-Jie Zhao, Taichung City (TW); Yu-Tsang Hsieh, Hsinchu County (TW)

(21) Appl. No.: 17/701,095

(22) Filed: Mar. 22, 2022

Related U.S. Application Data
(63) Continuation-in-part of application No. 16/996,540, filed on Aug. 18, 2020.

(51) Int. Cl. G06F 30/27; G06N 5/00; G06K 9/62

(52) U.S. Cl. CPC G06F 30/27; G06N 5/003; G06F 2111/20; G06K 9/6232; G06K 9/6257

(57) ABSTRACT

A method for recognizing various analog circuit structures is proposed, which is executed by a computer, the method comprising using the computer to perform the following: performing a feature extraction of a training circuit to extract all sub-circuits for generating multiple training samples; classifying multiple training samples by a classifier to obtain classified building blocks; performing a feature extraction of each schematic of a target circuit to convert as a feature graph and encoding feature graph as a feature matrix; classifying feature matrix by the classifier to generate multiple groups of classified devices; and clustering multiple groups of classified devices to acquire identified sub-circuits.

### TECHNICAL FIELD

The present invention relates to an analog circuit recognition technique, and more particularly, to a method for recognizing various analog circuit structures.

### BACKGROUND

Analog circuit designs are quite different from digital circuit designs from a layout perspective. Unlike a large-scale digital design, an analog circuit design usually has a relatively small scale, i.e., an analog circuit typically has a relatively small die size. However, its physical behavior is very sensitive to the layout geometry, e.g., parasitic coupling effect, small signal transmission, wiring crossovers, etc. Hence, area minimization is usually not a concern for an analog circuit design. A digital circuit designer can leverage mature commercial electronic design automation (EDA) tools to automate layout generation. However, the existing and popular way to generate an analog circuit layout is far from automatic. The manual, time-consuming, error-prone task highly depends on the layout designer's experience and wit. However, analog circuit design automation has become desirable.

Traditionally, analog circuitry has been manually laid out into its semiconductor mask layers for semiconductor manufacturing. This is because a human layout designer typically was experienced in analog circuit layout with prior knowledge, experience, and skill as to how the devices in an analog circuit were laid out so as to provide better performance and/or better noise immunity. The human layout designer can make some choices up front prior to laying out the analog circuitry. However, the number of choices that can be made up-front prior to layout by a human layout designer are limited. Moreover, a human layout designer requires considerable time to layout an entire analog circuit chip.

The traditional approach might not be sufficient for solving the problem effectively. Therefore, the invention proposes a new approach resulting in runtime improvement without sacrificing accuracy.

### SUMMARY OF THE INVENTION

In this invention, a method for recognizing various analog circuit structures is proposed, which is executed by a computer, the method comprising using the computer to perform the following: performing a first feature extraction of a training circuit to extract all sub-circuits for generating multiple training samples; classifying the multiple training samples by a classifier to obtain classified building blocks; performing a second feature extraction of each schematic of a target circuit to convert as a feature graph and encoding the feature graph as a feature matrix; classifying the feature matrix by the classifier to generate multiple groups of classified devices based on the classified building blocks; and clustering the multiple groups of classified devices to acquire identified sub-circuits.

According to one aspect, the method further comprises storing the classified building blocks in a sub-circuit library.

According to another aspect, the classifier is used to automatically identify a type of each of all building blocks.

According to one aspect, the multiple training samples comprises a feature matrix and a label matrix, and the classifier is utilizing a classified model to classify the multiple training samples in a training sample set. The classified model includes decision tree, neural network. The classified model is performed by a machine learning algorithm. The machine learning algorithm includes a feature extraction process and the classified model.

According to one aspect, the encoded feature graph is indicated by a number, and encoded feature graph with the number is one-to-one mapping.

In the invention, a non-transitory computer-readable medium containing instructions is proposed, which when read and executed by a computer, cause the computer to execute a method for recognizing various analog circuit structures, wherein the method comprises the above-mentioned steps.

### BRIEF DESCRIPTION OF THE DRAWINGS

The components, characteristics and advantages of the present invention may be understood by the detailed descriptions of the preferred embodiments outlined in the specification and the drawings attached:

FIG. 1 shows a schematic diagram of a method for recognizing various analog circuit structures;

FIG. 2 shows an exemplary CMOS cascade operational transconductance amplifier (OTA);

FIG. 3 illustrates an analog building block recognition corresponding to FIG. 2;

FIG. 4 shows a connection graph representation for the OTA in FIG. 2;

FIG. 5 shows the encoded features of each sub-circuits;

FIG. 6 illustrates the encoded features of each sub-circuits;

FIG. 7 shows the schematic and the feature graph of 4 transistor current mirror (4TCM);

FIG. 8 illustrates a feature matrix of 4 transistor current mirror (4TCM);

FIG. 9 illustrates a device clustering; and

FIG. 10 illustrates an example of device clustering.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

In order to gain more experts' knowledge during analog layout generation, the present invention describes a model training and a circuit recognition process to produce a new analog circuit structure (layout). The proposed algorithm includes two major stages: the model training by an artificial intelligence (AI) model and the circuit recognition described as the following. Embodiments of the present invention may be used in a variety of layout applications.

Utilizing a design repository containing legacy design schematics/netlists, the proposed method analyzes the design data of each sub-circuit, and stores the analyzed data in a sub-circuit library (database). In circuit design, a netlist is a description of the connectivity of an electronic circuit. A sub-circuit is a basic building block with a circuit function (e.g., current mirror, differential pair). In addition to the analog building block, any customized analog or digital basic circuit (e.g., inverter) also belong to a sub-circuit.

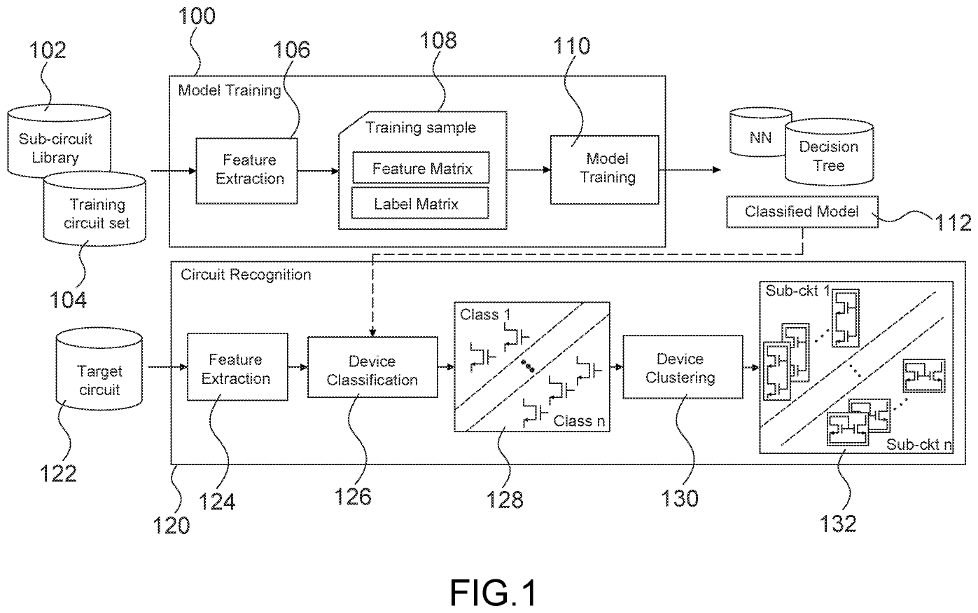

As shown in FIG. 1, a schematic diagram of a method for recognizing various analog circuit structures is described. The flow is carried out in two stages. First, it needs to train a model to learn the connection of circuits. Next, based on the trained model, the sub-circuit types for each device in complex target circuits can be classified. Finally, the true sub-circuits can be identified based on the device clustering algorithm.

The proposed algorithm includes two major stages: the model training 100 by an artificial intelligence (AI) model and the circuit recognition 120. A target circuit is a complex circuit consists of sub-circuits. Based on the above terminologies, the problems of sub-circuit extraction can be formulated as follows: model training and device clustering.

The process of the model training 100 includes feature extraction, training sample generation, and machine learning model. In the beginning, it needs to specify a set of sub-circuits (e.g., current mirror, differential pair) which are desired to identify. In order to extract the connection as features of machine learning model, sub-circuits netlists are encoded to get the feature list. Then, the feature matrix and label matrix are generated according to the feature list. Finally, the machine learning models with both of the two matrices are trained. Machine Learning Models include for example, Decision Tree Model (Each classification tree denotes a classifier for one class), or Deep Neural Network Model.

The method for recognizing various analog circuit structures in the invention comprises a step of preparing/inputting a complex analog circuit netlist and user-specified building blocks. A set of identified sub-circuits are outputted. For example, the netlist may be described in a Simulation Program with Integrated Circuit Emphasis (SPICE) format, and the design constraints are annotated into the netlist. Sub-circuits as analog circuit cells are identified as building blocks, which may refer to Wu et al., “A novel analog physical synthesis methodology integrating existent design expertise”, IEEE TCAD-2015. Each sub-circuit corresponds to some matched place-and-route (P&R) patterns which are chosen by a layout synthesizer.

In the stage of the model training 100, based on circuit information of the training circuit set, a process of a feature extraction 106 of the training circuit is performed by a feature extraction unit (module) to extract all sub-circuits for generating multiple training samples 108. In this stage, a model is trained to learn the connection of circuits. Then, the training samples is classified by a model training procedure 110. For example, the model training is performed by a machine learning algorithm based on feature (characteristics) of the training samples 108. The training circuit set 104 is provided to train the neural network to classify training samples. The sub-circuit library (database) 102 provides building blocks data required for training circuit set 104. Then, the feature extraction 106 is performed by a feature extraction unit (module) to obtain training sample 108 through the training circuit inputting.

The training sample set is a set of training samples for training a classifier, such as decision tree classifier or neural network classifier, where the training sample includes a feature matrix and a label matrix corresponding to preset classification condition feature. The classifier is utilizing a classified model 112 (decision tree, neural network) to classify the training samples 108 in the training sample set according to the classification condition, and acquire a classification subset (classified building blocks). The classified building blocks are stored in the sub-circuit library (database) 102.

After the classification condition is determined, the training samples in the training sample set may be classified according to the classification condition or feature, so as to obtain a classification subset.

In the stage of the circuit recognition procedure 120, the schematic of the target circuit 122 is an input data. In the feature extraction 124, the schematic of the target circuit 122 is converted to be a corresponding connection graph or feature graph by the feature extraction unit (module), and then the connection graph is encoded as a feature matrix. The proposed circuit coding scheme embeds the information of netlist into features. A unique matrix representation is applied to encode the connection graph or feature graph of the target circuit. Then, the device classification 126 procedure is performed by a classified model 112 to generate multiple groups of classified devices 128 based on the classified building blocks. In one embodiment, the invention proposes a decision tree learning algorithm for sub-circuits classification to improve the runtime comparing with traditional deterministic method. Each building block of the groups of classified devices 128 is stored in the sub-circuit library (database) 102. Finally, the device clustering 130 procedure for the classified devices 128 is performed to acquire identified sub-circuits 132 to create an analog circuit structure. The clustering algorithm can effectively identify sub-circuit groups which can also fix the problem of over prediction in models.

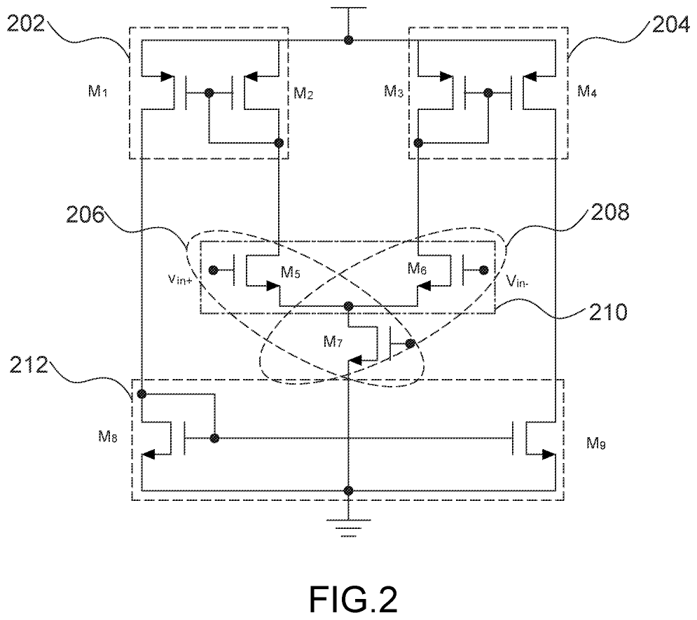

Given a set of legacy schematics and legacy layouts, a design database is first constructed based on a connection graph representation. Since a basic connection graph can only represent logical information corresponding to a schematic, some important physical information is further annotated from the corresponding legacy layout into the connection graph. A device type is tagged on each node. The target circuit is shown in FIG. 2 which shows the legacy schematic of an example CMOS cascade operational transconductance amplifier (OTA), which contains four PMOS transistors and five NMOS transistors. Each device could be included in different sub-circuits. That is, in FIG. 2, connection graph of each device of the target circuit to belong to which circuit patterns (building blocks) is recognized by a classifier such that a first device of the target circuit is included in different building blocks of the plurality of building blocks. It should be noted that the proposed circuit pattern (building block) recognition does not directly identify the circuit pattern. It identifies the external and self-connection relationship of each device, to determine which circuit patterns (building blocks) may belong to. The self-connection feature is greatly helpful for model training. Then, devices with connecting and belonging to the identical circuit pattern (building block) are clustered. In addition, the proposed method can allow a device to belong to multiple circuit patterns; that is, there is overlapped between different circuit patterns. The traditional methods are not allowed.

A coding scheme is briefly introduced, terminal connection index (TCI), that proposed by Wu et al. (P.-H. Wu, M. P.-H. Lin, T.-C. Chen, C.-F. Yeh, X. Li, and T.-Y. Ho, “A novel analog physical synthesis methodology integrating existent design expertise,” IEEE Transactions on Computer-Aided Design of Integrated Circuits and Systems, vol. 34, no. 2, pp. 199-212, 2014). They adopted a coding scheme to construct the connection graph that is a circuit representation for layout migration. The coding scheme describes the connections between terminals of each device.

The invention proposes a new coding scheme embedded device types and connections by adding 2 selection bits. In the following table, 2 bits are selected to represent the device connection itself and different types of device connections. DPTC_{i,j} denotes the device pair type code if there is a connection between Dᵢ and Dⱼ. For example, if DPTC_{i,j} equals 10, Dᵢ and Dⱼ are P type MOSFET, furthermore, Dᵢ and Dⱼ are the same device. In addition, the self-connection code is major for clustering algorithm. Notice that the prior coding scheme don't include self-connection information, as a result, it will reduce the accuracy for sub-circuit identification.

| DPTC_{i,j} | Dᵢ | Dⱼ |
|---|---|---|
| 00 | P | P |
| | N | N |
| 01 | N | P |
| | P | N |
| 10 | P (self) | P (self) |
| | N (self) | N (self) |

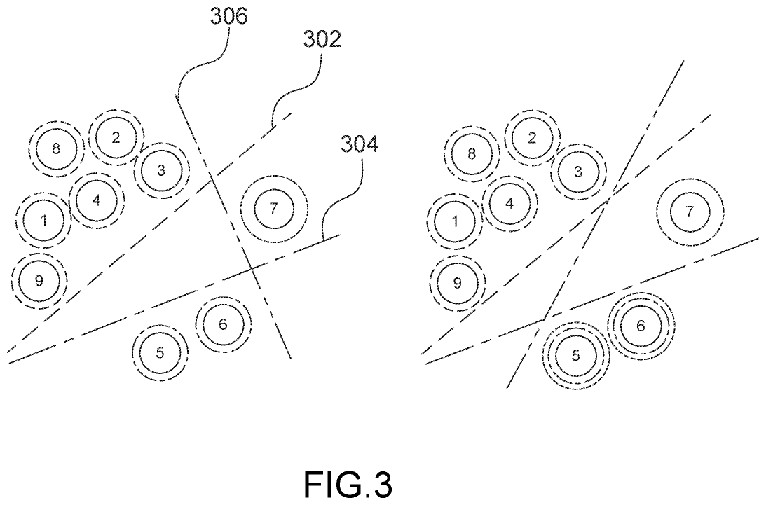

As shown in FIG. 3, node 1 represents PMOS device M1, node 2 represents PMOS device M2, node 3 represents PMOS device M3, and node 4 represents PMOS device M4. Similarly, node 5 represents NMOS device M5, node 6 represents NMOS device M6, node 7 represents NMOS device M7, node 8 represents NMOS device M8, and node 9 represents NMOS device M9. Each device could be included in different sub-circuits. Referring to FIG. 2, the PMOS device M1 and M2 are included in sub-circuit 202, and the PMOS device M3 and M4 are included in sub-circuit 204. Similarly, the NMOS device M5 and M7 are included in sub-circuit 206, the NMOS device M6 and M7 are included in sub-circuit 208, the NMOS device M5 and M6 are included in sub-circuit 210, and the NMOS device M8 and M9 are included in sub-circuit 212. The number 302, 304 and 306 indicates boundary of current mirror (cm), boundary of differential pair (dp) and boundary of cascode pair (cp), respectively.

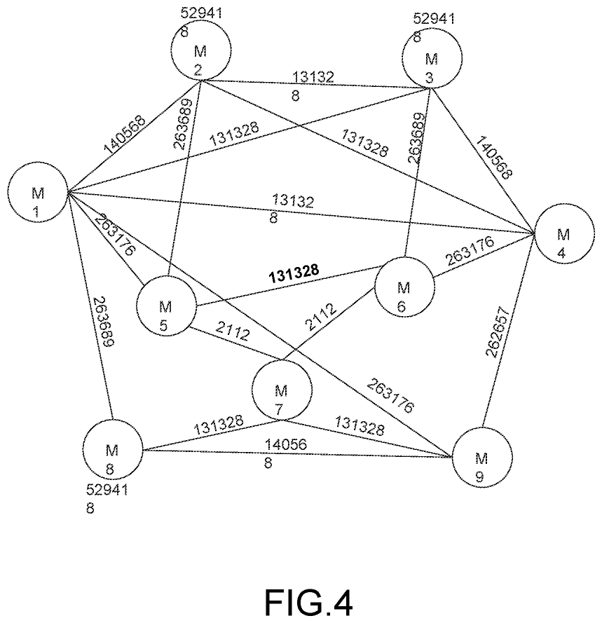

FIG. 4 illustrates a connection graph representation for the OTA in FIG. 2 according to an embodiment of the present invention. Similarly, all the other interconnection codes corresponding to each edge in the connection graph can be obtained, and the connection graph containing all interconnection codes is shown in FIG. 4. Each vertex represents a device. An edge exists between vertices if the devices are connected. For example, circuit function of the current mirror (cm) between the PMOS device M1 and the PMOS device M2, between the PMOS device M3 and the PMOS device M4, and between the NMOS device M8 and the NMOS device M9 has code number of 140568. The circuit function of the differential pair (dp) between the PMOS device M1 and the PMOS device M3, between the PMOS device M2 and the PMOS device M3, the PMOS device M1 and the PMOS device M4, the PMOS device M2 and the PMOS device M4, between the NMOS device M5 and the NMOS device M6, between the NMOS device M7 and the NMOS device M8, and between the NMOS device M7 and the NMOS device M9 has code number of 131328. The circuit function of the cascode pair (cp) between the NMOS device M5 and the NMOS device M7, and between the NMOS device M6 and the NMOS device M7 has code number of 2112. Code number of the vertices, the PMOS device M2, the PMOS device M3 and the NMOS device M8, is 528418. All features, including device types, circuit sizing, interconnection relationships, special connection to voltage/current sources, etc., are encoded. The code number of the feature graph between vertices is unique. That is, the feature graph with the code number is one-to-one mapping.

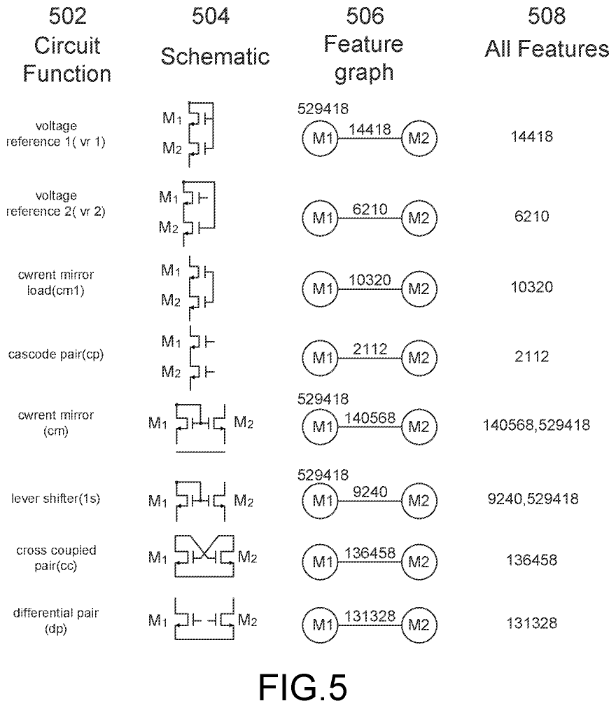

In the stage of the circuit recognition procedure, the schematic of the target circuit 122 is an input data. In the feature extraction 124, the schematic of the target circuit 122 is converted to be the corresponding connection graph by the feature extraction unit (module), and the connection graph is encoded as a feature matrix. For example, as shown in FIG. 5, the schematic 504 of the target circuit (M1-M2) corresponds to the following circuit function 502: a voltage reference 1 (vr 1), a voltage reference 2 (vr 2), a current mirror load (cm1), a cascode pair (cp), a current mirror (cm), a level shifter (1s), cross coupled pair (cc) and differential pair (dp) respectively, which can either be given by designers or automatically extracted. The schematic 504 of the target circuit is converted to the feature graph 506, and the feature (connection) graph is transferred as a feature matrix including all features 508, where each of all features is labelled by a number, including 14418, 6210, 10320, 2112, (140568, 529418), (9240, 529418), 136458 and 131328.

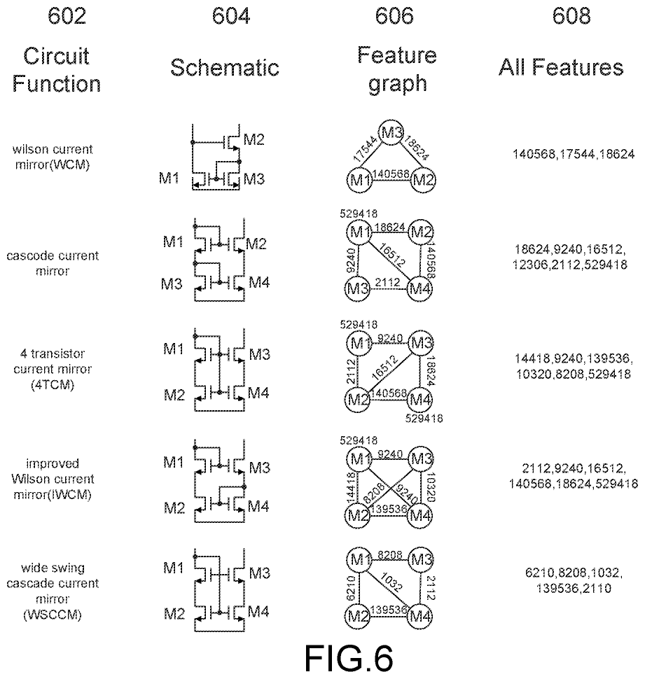

Similarly, as shown in FIG. 6, the schematic 604 of the target circuit (M1, M2, M3, M4) corresponds to the following circuit function 602: a Wilson current mirror load (WCM), a cascode current mirror, a 4 transistor current mirror (4TCM), an improved Wilson current mirror load (IWCM) and wide swing cascode current mirror (WSCCM) respectively, which can either be given by designers or automatically extracted. The schematic 604 of the target circuit is converted to the feature graph 606, and the feature (connection) graph is transferred (recorded) as a feature matrix including all features 608, where each of all features is labelled by a number, including (140528, 17544, 18624), (18624, 9240, 16512, 12306, 2112, 529418), (14418, 9240, 139536, 10320, 8208, 529418), (2112, 9240, 16512, 140568, 18624, 529418) and (6210, 8208, 1032, 139536, 2110).

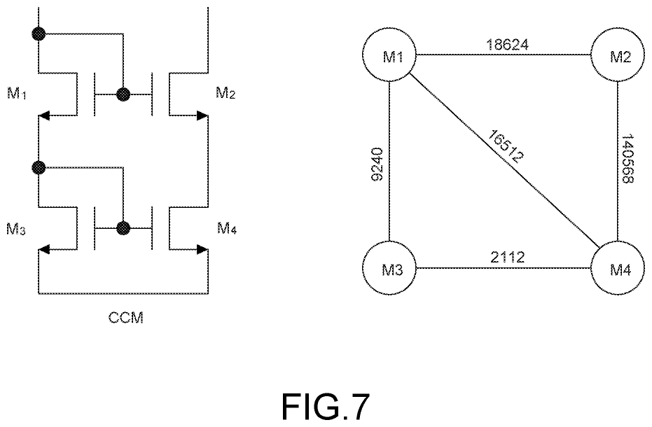

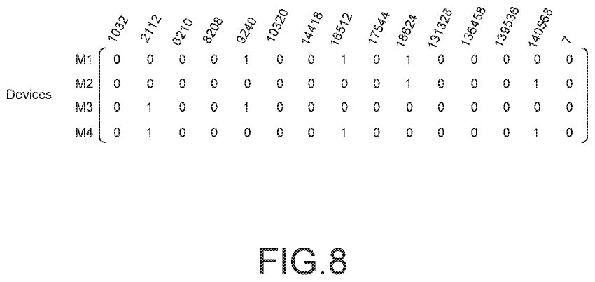

As shown in FIG. 7, it illustrates the schematic and the feature graph of 4 transistor current mirror (4TCM). Encoded features of 4 transistor in FIG. 7 is represented by the feature matrix, shown in FIG. 8, where the encoded feature graph is indicated by number 1032, 2112, 6210, 8208, 9240, 10320, 14418, 16512, 17544, 18624, 131328, 136458, 139s536, 140568 and 7. Each number can indicate an encoded feature between the devices M1, M2, M3 and M4.

The proposed method for the target circuit in which a computer performs processes of: extracting feature matrix of the target circuit; classifying the feature matrix to obtain multiple groups of classified devices; and clustering the classified devices to acquire identified sub-circuits. Therefore, a set of identified sub-circuits are outputted. The method for recognizing various analog circuit structures is finished.

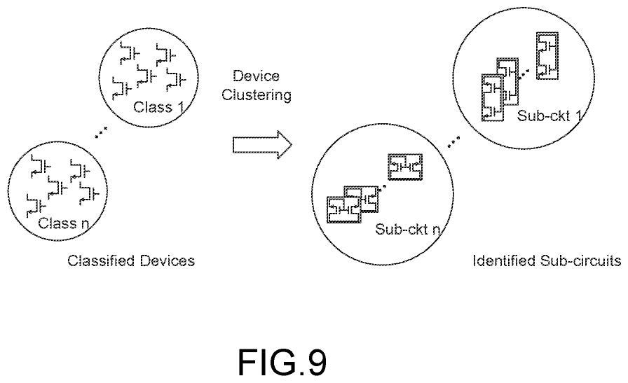

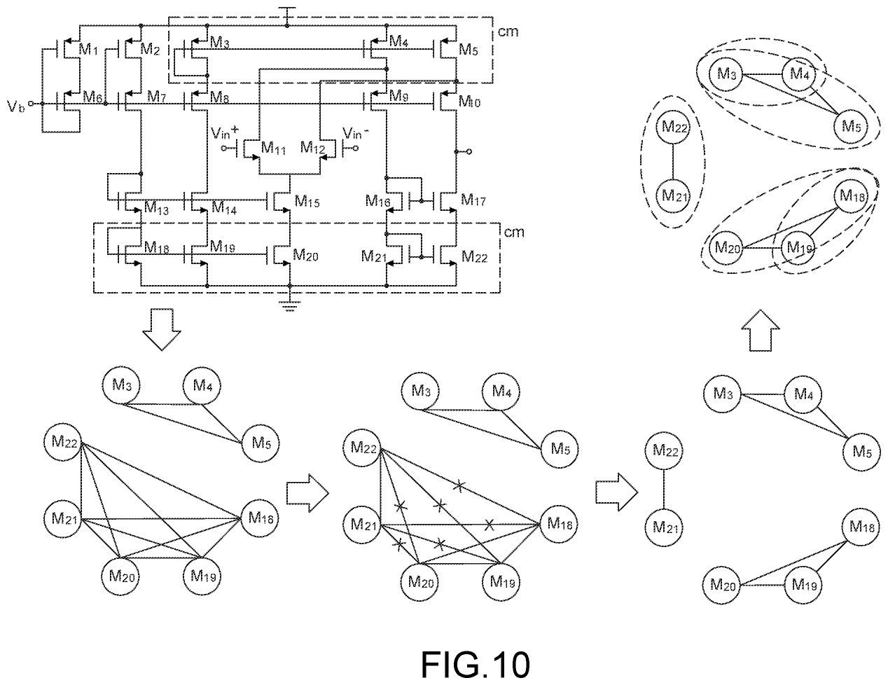

As shown in FIG. 9, the classified devices (class 1, . . . , class n) are clustered into sub-circuits (Sub-ckt 1, . . . , Sub-ckt n) according to resulting prediction matrix. For an example of device clustering for a target circuit in FIG. 10, the devices M3, M4 and M5 are included in a connection graph, and the devices M18, M19, M20, M21 and M22 are included into another connection graph. Regardless of the connection “cross X” between the devices M18, M19, M20, M21 and M22, two connection graphs are inverted into three connection graphs. Accordingly, two type of sub-circuits are generated by device clustering, where the devices M3 and M4 are included in a first type sub-circuit and a second type sub-circuit, and the devices M18 and M19 are also included in the first type sub-circuit and the second type sub-circuit. As described above, the first connection graphs of all devices of the target circuit are classified into second connection graphs to obtain multiple groups of classified devices, wherein a first number of the first connection graphs is different from a second number of the second connection graphs.

The proposed circuit pattern (building block) recognition does not directly identify the circuit pattern. It identifies the external and self-connection relationship of each device, to determine which circuit patterns (building blocks) may belong to. Then, devices with connecting and belonging to the identical circuit pattern (building block) are clustered.

The output of machine learning model is a prediction result matrix. The matrix contains a set of prediction result for each device. The aim is to cluster devices into sub-circuits according to prediction result matrix. The invention proposes a novel approach to efficiently reduce search space by grouping algorithm.

Algorithm 1 shows the device clustering algorithm. The inputs of the algorithm are listed in the following.

Algorithm 1: Device Clustering

| | Input: | | | |
|---|---|---|---|---|
| | (1) P: a prediction result matrix. P ∈ [symbol] ^{(K)}; which i is number of devices, j is | | | |
| | number of class. | | | |
| | (2) T: a target circuit connection graph. T ∈ [symbol] [symbol] , which n is number of | | | |
| | devices in target circuit. | | | |
| | (3) [symbol] : a list of sub-circuit class number. | | | |
| | (4) [symbol] : a list of sub-circuit connection graph. For each sub-circuit k ∈ [symbol] , [symbol] [k] | | | |
| | ∈ [symbol] [symbol] , which m is number of device in sub-circuit. | | | |
| | Output: [symbol] : a set of identified sub-circuits. | | | |
| 1 | for k ∈ [symbol] do | | | |
| 2 | \| | [symbol] [symbol] ← ∅ | | |
| 3 | \| | [symbol] [symbol] ← Calculate the permutation of each row and column in [symbol] [k] // [symbol] [symbol] | | |
| | \| | contains a set of sub-circuit graphs of class k | | |
| 4 | \| | [symbol] ₖ ← column k of P | | |
| 5 | \| | [symbol] ₁ ← ∅ // [symbol] ₁ contains a set of device number of class k which prediction | | |
| | \| | results equal 1 | | |
| 6 | \| | for p ∈ [symbol] ₖ do | | |
| 7 | \| | \| | if p = 1 then | |
| 8 | \| | \| | \| | [symbol] ₁ ← (p) ∪ [symbol] ₁ |
| 9 | \| | \| | end | |
| 10 | \| | end | | |
| 11 | \| | [symbol] ← ∅ // [symbol] contains a set of device number after grouping algorithm | | |
| 12 | \| | Grouping ( [symbol] ₁, [symbol] ) | | |
| 13 | \| | for [symbol] [symbol] ∈ [symbol] do | | |
| 14 | \| | \| | [symbol] [symbol] ← ∅ // [symbol] [symbol] contains a set of device number after combination | |
| 15 | \| | \| | [symbol] [symbol] ← Calculate the combination of [symbol] [symbol] | |
| 16 | \| | \| | for [symbol] [symbol] ∈ [symbol] [symbol] do | |
| 17 | \| | \| | \| | // T( [symbol] [symbol] ) denotes a graph which consists of nodes [symbol] [symbol] |
| 18 | \| | \| | \| | if T( [symbol] [symbol] ) ∈ [symbol] [symbol] then |
| 19 | \| | \| | \| | \| [symbol] ← [symbol] [symbol] |
| 20 | \| | \| | \| | end |
| 21 | \| | \| | end | |
| 22 | \| | end | | |
| 23 | end | | | |

[symbol]

indicates data missing or illegible when filed

The notation and description are listed in the following.

P: a matrix comes from the inference of machine learning models. Each row denotes the device label, and each column denotes a class. For example, in FIG. 2, if M1 has a current mirror label after inference, the row of M1 in column c (if column c denotes current mirror label) equal one, and other column in the M1 row will be zero. Notice that it can exist more than one 1 for each row because of the multilabel classification. For instance, M5 can belong to cascode pair and differential pair simultaneously.

T: a connection graph of target circuit. To simply, a matrix is used to denote a graph. The upper triangle of matrix denotes code DPC_{i→j}, and the lower triangle of matrix denotes code DPC_{j43 i}. The diagonal of matrix denotes self-connections. The connection graph is encoded as a feature matrix, and diagonal of the feature matrix denotes self-connections of device.

K: a list of sub-circuit class number. Notice that the number of classes must be the same as the number of labels in machine learning models.

S: a list of sub-circuit connection graph. If k classes of sub-circuits are defined, there will be k items in set S. Each item denotes a sub-circuit connection graph which are converted to a matrix as aforementioned definition.

| Notation | Description |
|---|---|
| P | Prediction result of a model |
| T | Connection graph of a target circuit |
| [symbol] | A set of sub-circuit class numbers |
| [symbol] | A set of sub-circuit connection graphs |
| [symbol] | A set of identified sub-circuits |
| [symbol] | A set of sub-circuit graphs after permutation |
| [symbol] | The k^{th} column of P |
| [symbol] | A set of device number which [symbol] equal 1 |
| [symbol] | A set of device number after grouping |
| [symbol] | A set of device number after combination |
| [symbol] | A set of groups after first grouping |
| [symbol] | A set of groups after second grouping |
| [symbol] | A value popped from [symbol] |

In order to match between sub-circuit graphs and target circuit graphs, it should find the permutation of devices in sub-circuit graphs which is showed in line 3 of algorithm 1. Notice that the complexity of permutation will not be too high because of the small size of sub-circuits. For line 6 to 10 in algorithm 1, devices whose prediction results are equal to 1 are extracted for class k according to P, and store to P1 for further using.

Algorithm 2 shows the grouping algorithm to reduce the search space. The concept of grouping algorithm is pruning connection graph according to circuit feature graphs.

Algorithm 2: Grouping

| 1 | Function Grouping ( [symbol] ₁, [symbol] ) : | | | | | |
|---|---|---|---|---|---|---|
| 3 | \| | while [symbol] ₁ ∉ ∅ do | | | | |
| 4 | \| | \| | [symbol] [symbol] ₁ ← ∅ // [symbol] [symbol] ₁ contains a set of device number after first grouping | | | |
| 5 | \| | \| | [symbol] [symbol] ← pop a value in [symbol] ₁ | | | |
| 6 | \| | \| | for p ∈ [symbol] ₁ do | | | |
| 7 | \| | \| | \| | if ∃ T[ [symbol] ₁][p] and T[ [symbol] ₁][p] ≠ 0 then | | |
| 8 | \| | \| | \| | \| | [symbol] [symbol] ₁ ← {p} ∪ [symbol] [symbol] ₁ | |
| 9 | \| | \| | \| | end | | |
| 10 | \| | \| | end | | | |
| 11 | \| | \| | for [symbol] ∈ [symbol] [symbol] ₁ do | | | |
| 12 | \| | \| | \| | [symbol] ₁ ← [symbol] ₁ − { [symbol] } | | |
| 13 | \| | \| | end | | | |
| 14 | \| | \| | for [symbol] ∈ [symbol] [symbol] ₁ do | | | |
| 15 | \| | \| | \| | [symbol] [symbol] ₂ ← ∅ // [symbol] [symbol] ₂ contains a set of device number after second | | |
| | \| | \| | \| | grouping | | |
| 16 | \| | \| | \| | for g₂ ∈ [symbol] ₁ do | | |
| 17 | \| | \| | \| | \| | if ∃ T[g₁][g₂] ∈ [symbol] and T[g₁][g₂] ≠ 0 then | |
| 18 | \| | \| | \| | \| | \| | [symbol] [symbol] ₁ ← {g₂} ∪ [symbol] [symbol] ₁ |
| 19 | \| | \| | \| | \| | \| | [symbol] [symbol] ₂ ← {g₂} ∪ [symbol] [symbol] ₂ |

| 20 | \| | \| | \| | \| | end |
|---|---|---|---|---|---|
| 21 | \| | \| | \| | end | |
| 22 | \| | \| | \| | for g₂ ∈ [symbol] [symbol] ₂ do | |
| 23 | \| | \| | \| | \| | [symbol] ₁ ← [symbol] ₁ − {g₂} |

| 24 | \| | \| | \| | end |
|---|---|---|---|---|
| 25 | \| | \| | end | |
| 26 | \| | \| | [symbol] [symbol] ₁ ← ( [symbol] ₁) ∪ [symbol] [symbol] ₁ | |
| 27 | \| | \| | if \| [symbol] [symbol] ₁\| ≥ m then | |
| 28 | \| | \| | \| | [symbol] ← [symbol] [symbol] ₁ ∪ [symbol] |

| | | | |
|---|---|---|---|
| 29 | \| | \| | end |

| | | |
|---|---|---|
| 30 | \| | end |

| | |
|---|---|
| 31 | end |

[symbol]

indicates data missing or illegible when filed

FIG. 10 shows the connection graph of current mirror constructed by prediction results of models. If all devices in same class have fully connections, the connection graph is a complete graph which will lead to a time-consuming search task. FIG. 10 gives the connection graph of current mirror built by prediction results after grouping algorithm. The grouping algorithm can remove a great number of redundant connections/edges on original search graph according to circuit features graphs. The input of algorithm 2 is a set of prediction results P1 assigned by aforementioned preprocessing procedure. Grouping algorithm is carried out in two stages. The first stage called first grouping which is listed in line 5 to 13 in algorithm 2. First, a start node P_{f} is chosen and connections of P_{f} are searched. If the connection meets circuit features of class k, the device/node with respect to the connection will be appended to the first group. Otherwise, the device/node will be removed. However, the first grouping only group the devices/nodes which connect to P_{f}. The connections of other devices/nodes in first group will be searched on the second stage. The second stage of grouping algorithm called second grouping which is listed in line 14 to 25 in algorithm 2. For each device/node after first grouping, the connection is checked whether it meets circuit feature constraint of class k as aforementioned rule in first stage. If there is device/node meets the constraint, the first group will update. The operation of second grouping will iterate until all devices/nodes are searched. The second constraint is size constraint listed in line 27 to 29 in algorithm 2 also can reduce search space efficiently. The constraint will remove the group whose number of devices/nodes are less than sub-circuit size m of class k. Otherwise, the group will be reserved.

For example, if we want to group cascode pair, and P1 contains M11, M12, M15 and M20. First, M20 is popped as a start device/node. Searching devices/nodes which connect to M20 according to circuit feature graphs in first search. Second search will start from M15 since group set SG1 only contains M15 now. In this iteration of second search, M11 and M12 are appended to group set SG1. In next iteration of second search, the loop will be interrupted because neither the connection of M11 nor M12 meets circuit feature constraint. Now, the group set SG1 contains M11, M12, M15 and M20. Moreover, it also meets the size constraint since group size 4 is larger than sub-circuit size 2.

The purpose of algorithm 2 is reducing search space of prediction results from models which illustrated in FIG. 10. The algorithm 2 will prune connection graphs based on aforementioned two constraints. The first constraint is circuit feature constraint, the constraint can trim connections according to feature graphs. The predicted devices will be separate as much group as possible in this procedure. For example, folded cascode OpAmp in FIG. 10, M6 to M10 and M13 to M17 are seen as one level shifter group. After applying grouping algorithm, M6 to M10 and M13 to M17 are separated to two level shifter groups. Obviously, if there is a group consists of PMOS and NMOS, they will be separated to different groups according to the nature of features. Another constraint is size constraint which can filter out a lot of fake groups. For instance, if a cascode current mirror group consisted of two devices is found, however, cascode current mirror consisted of four devices, the group will be removed in search space.

According to the invention, the machine learning algorithm includes a feature extraction process and a classification model.

The method further comprises providing a database for the machine learning algorithm. The machine learning algorithm includes at least one neural network and at least one classifier.

In the invention, a model training is performed by a machine learning algorithm to analyze and judge the feature graph of training sample, so as to automatically classify the type of the building blocks. For example, a classifier is used to automatically identify the type of the building blocks.

The algorithms of the machine learning can be executed by operation of computer. The experimental results show that the proposed method can successfully classify the training circuit, and achieve the accuracy rate of detection and classification 96% and 97% respectively, even higher accuracy.

In the present invention, the proposed algorithm may be implemented in the following experimental setup: programming language “Python 3.4”, library “Scikit-learn”, platform “2.6 GHz Intel CPU, GTX-1080 Ti GPU”, training circuits “textbooks, papers in the literature”, total training sample “385 circuits, 13580 devices”, training and testing ratio “90%:10%” and test circuits including “Folded Cascode OpAmp, Buffer Amp, Chopper OpAmp”, where Folded Cascode OpAmp uses twenty-two number of devices and twenty-seven number of sub-circuits, Buffer Amp uses forty-two number of devices and forty-one number of sub-circuits, and Chopper OpAmp uses one hundred-sixty number of devices and one hundred-sixteen number of sub-circuits.

Experimental results show in table 1. Compared with the graph-based deterministic approach, the proposed ML approach based on decision tree results in 8.5× runtime improvement without sacrificing accuracy. That is, the proposed framework achieves 8.5 speedup than the previous method.

TABLE 1

| | | | Graph-based | | | | | | |
|---|---|---|---|---|---|---|---|---|---|
| Target Circuit | | | Deterministic Approach | | Proposed ML Approach based on Decision Tree | | | | |
| | # | #Sub- | #identified | Time | #identified | Time (sec) | | | |
| Name | Device | circuit | sub-circuits | (sec) | sub-circuits | Setup | Prediction | Clustering | Total |
| Folded Cascode | 22 | 27 | 27 | 0.075 | 27 | 0.007 | 0.006 | 0.010 | 0.023 |
| OpAmp | | | | | | | | | |
| Buffer Amp | 42 | 41 | 41 | 0.260 | 41 | 0.016 | 0.006 | 0.053 | 0.075 |
| Chopper OPA | 160 | 116 | 112 | 2.335 | 112 | 0.059 | 0.023 | 0.024 | 0.106 |

| | | |
|---|---|---|
| Comparison | 8.585 | 1 |

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A non-transitory computer-readable medium containing instructions, which when read and executed by a computer, cause the computer to execute a method for recognizing various analog circuit structures, wherein the method comprises steps of:
performing a first feature extraction of a training circuit to extract all sub-circuits for generating multiple training samples;
classifying said multiple training samples by a classifier to obtain a plurality of building blocks;
performing a second feature extraction of each device of a target circuit to convert as a connection graph;
recognizing said connection graph of said each device of said target circuit to belong to which of said plurality of building blocks by said classifier such that a first device of said target circuit is included in different building blocks of said plurality of building blocks;
classifying first connection graphs of all devices of said target circuit into second connection graphs to obtain multiple groups of classified devices; and
clustering each group of said multiple groups of classified devices which belongs to an identical building block of said classified building blocks to acquire identified sub-circuits.

2. The non-transitory computer-readable medium of claim 1, wherein a first number of said first connection graphs is different from a second number of said second connection graphs.

3. The non-transitory computer-readable medium of claim 1, further comprising storing said classified building blocks in a sub-circuit library.

4. The non-transitory computer-readable medium of claim 1, wherein said classifier is used to automatically identify a type of each of said all building blocks.

5. The non-transitory computer-readable medium of claim 1, wherein said connection graph is encoded as a feature matrix, and diagonal of said feature matrix denotes self-connections of device.

6. The non-transitory computer-readable medium of claim 5, wherein said encoded connection graph is indicated by a number.

7. The non-transitory computer-readable medium of claim 1, wherein said classifier is utilizing a classified model to classify said multiple training samples in a training sample set.

8. The non-transitory computer-readable medium of claim 7, wherein said classified model includes decision tree or neural network.

9. The non-transitory computer-readable medium of claim 7, wherein said classified model is performed by a machine learning algorithm.

10. The non-transitory computer-readable medium of claim 9, wherein said machine learning algorithm includes a feature extraction process and said classified model.

11. A method for recognizing various analog circuit structures, which is executed by a computer, the method comprising:
using the computer to perform the following:
performing a first feature extraction of a training circuit to extract all sub-circuits for generating multiple training samples;
classifying said multiple training samples by a classifier to obtain classified building blocks;
performing a second feature extraction of each device of a target circuit to convert as a connection graph;
recognizing said connection graph of said each device of said target circuit to belong to which of said plurality of building blocks by said classifier such that a first device of said target circuit is included in different building blocks of said plurality of building blocks;
classifying first connection graphs of all devices of said target circuit into second connection graphs to obtain multiple groups of classified devices; and
clustering each group of said multiple groups of classified devices which belongs to an identical building block of said classified building blocks to acquire identified sub-circuits.

12. The method of claim 11, wherein a first number of said first connection graphs is different from a second number of said second connection graphs

13. The method of claim 11, further comprising storing said classified building blocks in a sub-circuit library.

14. The method of claim 11, wherein said classifier is used to automatically identify a type of each of said all building blocks.

15. The method of claim 11, wherein said connection graph is encoded as a feature matrix, and diagonal of said feature matrix denotes self-connections of device.

16. The method of claim 11, wherein said encoded connection graph is indicated by a number.

17. The method of claim 11, wherein said classifier is utilizing a classified model to classify said multiple training samples in a training sample set.

18. The method of claim 17, wherein said classified model includes decision tree or neural network.

19. The method of claim 17, wherein said classified model is performed by a machine learning algorithm.

20. The method of claim 19, wherein said machine learning algorithm includes a feature extraction process and said classified model.
